(19) United States
(12) Patent Application Publication
(10) Pub. No.: US 2017/0108955 A1
(43) Pub. Date: Apr. 20, 2017

(54) ERGONOMIC CAPACITANCE PEN

(71) Applicant: WALTOP INTERNATIONAL CORPORATION, Hsinchu City (TW)

(72) Inventors: CHUNG-FUU MAO, Hsinchu City (TW); HSIN-CHIANG HO, Hsinchu City (TW)

(21) Appl. No.: 14/964,305

(22) Filed: Dec. 9, 2015

(30) Foreign Application Priority Data
Oct. 16, 2015 (TW) 104134035

(51) Int. Cl. G06F 3/0354; G06F 3/044; G06F 3/038

(52) U.S. Cl. CPC G06F 3/03545; G06F 3/0383; G06F 3/044

(57) ABSTRACT

The present invention relates to an ergonomic capacitance pen. The ergonomic capacitance pen comprises an electrical signal transmitting module and a housing. The electrical signal transmitting module is deposited inside the housing. The electrical signal transmitting module comprises a core, a core holder, a spring, a sensor holder, a circuit board, and a battery holder. The battery holder is deposited on one surface of the circuit board and they are parallel with each other. When a battery is put into the battery holder, the battery and the circuit board are parallel with each other. Therefore, the gravity center of the ergonomic capacitance pen moves to the position near the head of the ergonomic capacitance pen, and the ergonomic capacitance pen can have a structure having best proportion of allocation for easily holding the ergonomic capacitance pen.

### CROSS REFERENCE

This application claims priority from Taiwan Patent Application No. 104134035, filed Oct. 16, 2015, the content of which are hereby incorporated by reference in their entirety for all purposes.

### BACKGROUND OF THE INVENTION

1. Field of the Invention

The present invention relates to an ergonomic capacitance pen, and particularly relates to an ergonomic capacitance pen which can have a structure having best proportion of allocation for easily holding the ergonomic capacitance pen by moving the gravity center of the ergonomic capacitance pen.

2. Description of the Prior Art

Along with popularization of touch devices, capacitance pens have been widely used to handwriting input (means input information by handwriting) to different touch devices (such as touch panel, touch screen phone, tablet PC, etc.).Referring to FIG. 1, it illustrates a conventional capacitance pen 100, and the back portion of the conventional capacitance pen 100 is in perspective view in FIG. 1. In the conventional capacitance pen 100, the battery holder 104 is deposited behind the circuit board. It means that the battery holder 104 is deposited in the tail end (or back end) of the conventional capacitance pen 100. Therefore, the gravity center of conventional capacitance pen 100 is located at the tail end (or back end) of the conventional capacitance pen 100. It means that the gravity center of conventional capacitance pen 100 is located at the upper portion of the conventional capacitance pen 100 when a user upright the conventional capacitance pen 100 and uses it for handwriting input. Most people are accustomed to use the conventional capacitance pen 100 with a slight tilt. Therefore, the gravity center of conventional capacitance pen 100 is located at the upper portion of the conventional capacitance pen 100 when people use the conventional capacitance pen 100 for handwriting input. It is because the weight of the upper portion (or tail end) of the conventional capacitance pen 100 is increased after the battery put into the battery holder. It increases the burden of hand when people use the conventional capacitance pen 100 and thereby it causes pain of the hand after using the conventional capacitance pen 100 for long time. Therefore, for people who need to use the conventional capacitance pen 100 for long time (such as authors, illustrators, etc.), it is not comfortable to use the conventional capacitance pen 100 for long time. The conventional capacitance pen 100 is not suitable for long-time using because it results in the pain of the hand.

Therefore, it has a need of an capacitance pen which is comfortable and suitable for long-time using without the pain of the hand.

### SUMMARY OF THE INVENTION

In view of the foregoing, one object of the present invention is to provide an ergonomic capacitance pen for solving the drawbacks of the conventional capacitance pen. By changing where the battery is put in the ergonomic capacitance pen, the gravity center of the ergonomic capacitance pen is moved to the head portion (or the front portion or the lower portion) of the ergonomic capacitance pen. Therefore, the ergonomic capacitance pen can have a structure having best proportion of allocation for easily holding the ergonomic capacitance pen, and it is comfortable and suitable for long-time using without the pain of the hand.

According to one of the objects above, an ergonomic capacitance pen is disclosed herein. The ergonomic capacitance pen comprises an electrical signal transmitting module and a housing. The electrical signal transmitting module is deposited inside the housing for emitting an electrical signal to a touch panel device (such as touch panel, touch screen phone, tablet PC, etc.). The electrical signal transmitting module comprises a core, core holder, a spring, a sensor holder (having a sensor therein), a circuit board, and a battery holder. The battery holder is deposited on one surface of the circuit board and they are parallel with each other. When a battery is put into the battery holder, the battery and the circuit board are parallel with each other. Therefore, the gravity center of the ergonomic capacitance pen moves to the position near the head of the ergonomic capacitance pen, and the ergonomic capacitance pen can have a structure having best proportion of allocation for easily holding the ergonomic capacitance pen. It makes the ergonomic capacitance pen to be comfortable and suitable for a user to use for a long time without the pain of the hand.

Therefore, the present invention provides an ergonomic capacitance pen having a structure which has best proportion of allocation for easily holding the ergonomic capacitance pen. It allows the user to use the ergonomic capacitance pen for a long time without the pain of the hand.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a drawing illustrating a conventional capacitance pen.

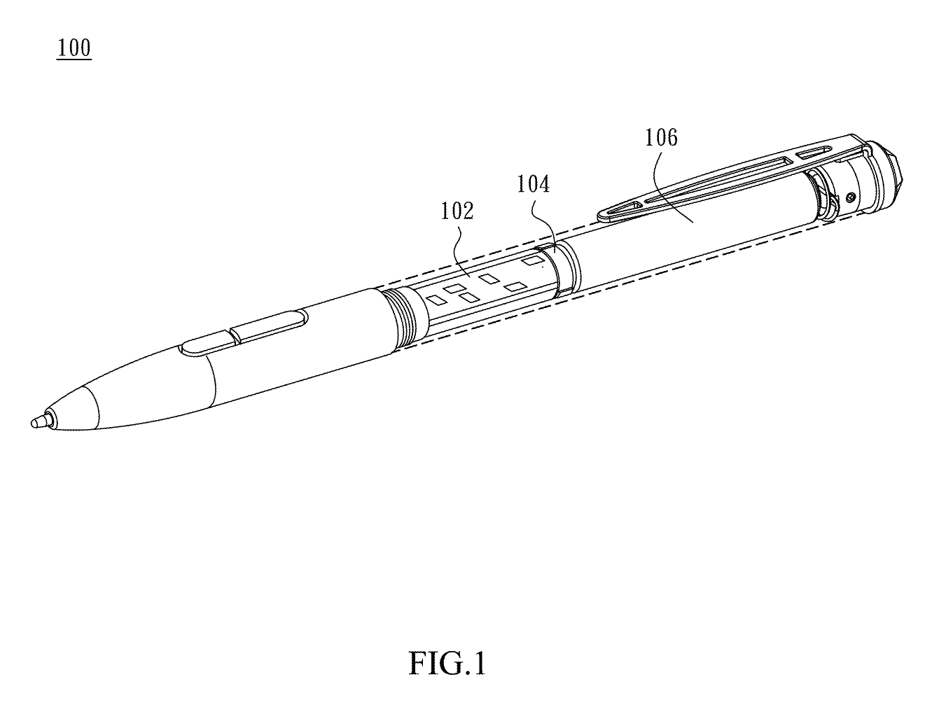

FIG. 2 is an explosion drawing illustrating an ergonomic capacitance pen in accordance with one embodiment of the present invention.

FIG. 3 is a drawing illustrating an ergonomic capacitance pen in accordance with one embodiment of the present invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components. Although specific embodiments have been illustrated and described, it will be appreciated by those skilled in the art that various modifications may be made without departing from the scope of the present invention, which is intended to be limited solely by the appended claims.

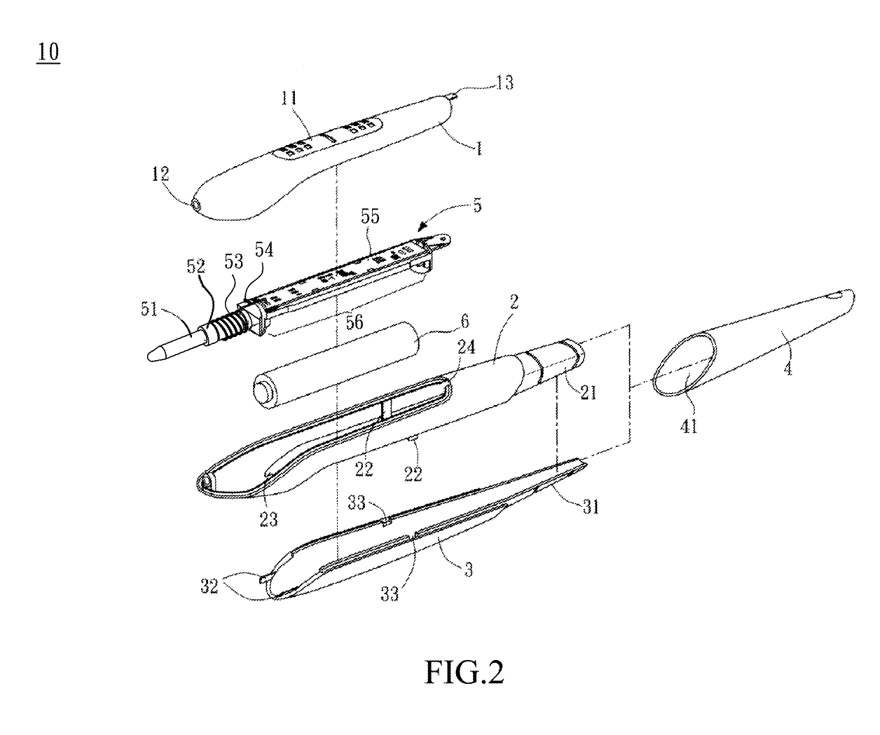

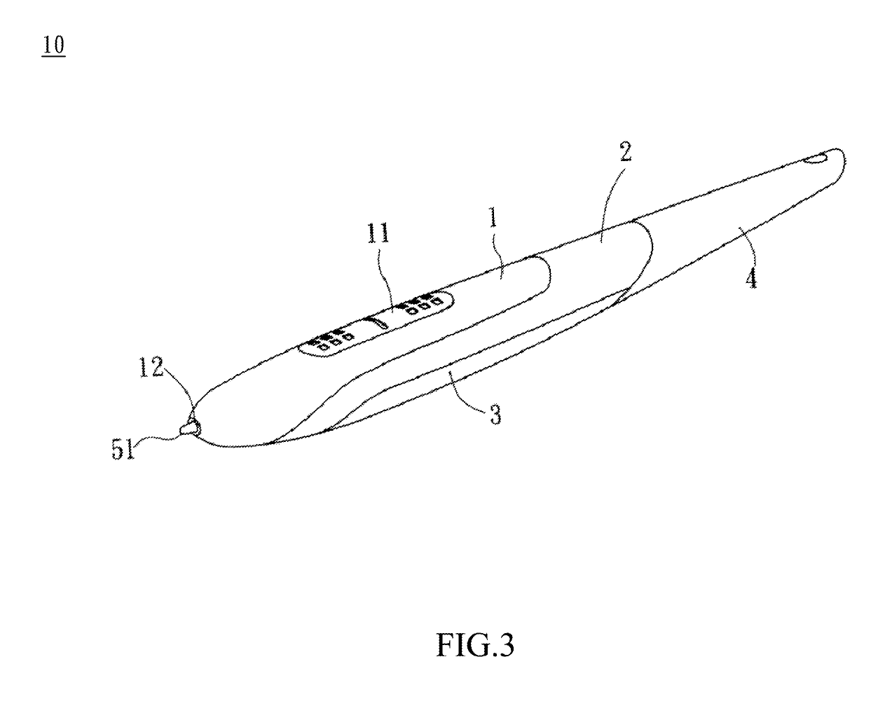

Please refer to FIG. 2 and FIG. 3 simultaneously, FIG. 2 is an explosion drawing illustrating an ergonomic capacitance pen 10 in accordance with one embodiment of the present invention, and FIG. 3 is a drawing illustrating the ergonomic capacitance pen 10 in accordance with one embodiment of the present invention. The ergonomic capacitance pen 10 comprises a housing and an electrical signal transmitting module 5. The electrical signal transmitting module is deposited inside the housing and is covered by the housing for emitting an electrical signal to a touch panel device (such as touch panel, touch screen phone, tablet PC, etc.). By emitting the electrical signal, the user can use the ergonomic capacitance pen 10 for handwriting input (means input information by handwriting) to the touch device. The electrical signal transmitting module 5 comprises a core 51, a core holder 52, a spring 53, a sensor holder 54, a circuit board 55, and a battery holder 56. The tail end of the core 51 is deposited in the core holder 52. It means that the tail end (or back end) of the core 51 is installed into the core holder 52. The spring 53 is looped around the core holder 52 and one end of the spring 53 is electrically connected with the circuit board 55. The core 51, the core holder 52, the spring 53 are made of conductive materials (such as metal, etc.) and thereby the electrical signal (or current) generated by the circuit board 55 can be transmitted to the core 51 through the spring 53 and the core holder 52. And then, the electrical signal (or current) can be transmitted to the touch device through the core 51 when the user uses the ergonomic capacitance pen 10 to write on the touch device. The sensor holder 54 holds or contains a sensor (not showed in FIG. 2 and FIG. 3) therein for detecting the pressure variation caused by the movement of the core 51 or the core holder 52. When the user use the ergonomic capacitance pen 10 to write on a writing surface of the touch device, the nib (the head or front end of the core 51) of the ergonomic capacitance pen 10 moves backward because it is pressed by the writing surface of the touch device. It means that the core 51 and the core holder 52 moves backward and press the sensor in the sensor holder at this time. Therefore, a pressure is formed and performed to the sensor in the sensor holder when the core 51 and the core holder 52 moves back. When the sensor detects the pressure caused by movement (moving back) of the core 51 and the core holder 52, the sensor informs the circuit board 55 to generate the electrical signal (or current) and transmit the electrical signal (or current) to the writing surface of the touch device through the spring 53, the core holder 52, and the core 51 for handwriting input. When the nib (the head or front end of the core 51) of the ergonomic capacitance pen 10 leaves the writing surface of the touch device, the front end (or head) of the core 51 moves forward and back to the original position in the ergonomic capacitance pen 10 because the nib (the head or front end of the core 51) of the ergonomic capacitance pen 10 is not pressed by the writing surface of the touch device anymore. It means that the core 51 and the core holder 52 moves forward and back to the original position in the ergonomic capacitance pen 10. At this time, the sensor in the sensor holder is no longer pressed by the core 51 and the core holder 52, and thereby, there is no pressure performed to the sensor. When the sensor does not detect the pressure caused by the core 51 and the core holder 52, the sensor informs the circuit board 55 to stop generating the electrical signal (or current) and transmitting the electrical signal (or current) to the writing surface of the touch device.

The battery holder 56 is deposited on the lower (or bottom) surface of the circuit board 55, and the battery holder 56 and the circuit board 55 are parallel with each other. Therefore, when the battery 6 is put into the battery holder 56, the body of the battery 6 and the circuit board 55 are parallel with each other. It makes the gravity center of the ergonomic capacitance pen 10 to move to the position near the head of the ergonomic capacitance pen. Therefore, the ergonomic capacitance pen 10 can have a structure having best proportion of allocation for easily holding the ergonomic capacitance pen 10. Although it makes the portion of the ergonomic capacitance pen 10, which the user holds to write, slightly bigger, but it decreases the burden of hand when the user uses of holds the ergonomic capacitance pen 10. Therefore, the user can use the ergonomic capacitance pen 10 for a long time without the pain of the hand. Although the battery holder 56 is deposited on the lower (or bottom) surface of the circuit board 55 in the ergonomic capacitance pen 10 illustrated in FIG. 2, but it is not a limit. In another embodiment of this invention, the battery holder 56 may be deposited on the upper (or top) surface of the circuit board 55. The battery 6 may be a dry cell or a rechargeable Nickel-Metal Hydride battery. In the best embodiment of this invention, it prefers AAA battery. It is because the AAA battery is easy to be obtained, cheaper, and lighter (comparing with the AA battery).

The housing of the ergonomic capacitance pen 10 comprises a first shell 1, a second shell 2, a third shell 3, and a fourth shell 4. The first shell 1 comprises a button 11, a through hole 12, and a first tenon 13. The through hole12 and the first tenon 13 are deposited on the two ends (front end and back end) of the ergonomic capacitance pen 10 respectively. The button 11 is deposited on the upper surface of the first shell 1. When the user press the button 11, the circuit board 53 is switched on for generating the electrical signal (or current). The touch device finds the position and the coordinates of the ergonomic capacitance pen 10 on the touch device by the electrical signal (or current). The second shell 2 comprises a narrow end 21, a two second tenons 22, two recessed holes 23, and a notch 24. The third shell 3 comprises a narrow end 31, two third tenons 32, and two notches 33. The fourth shell 4 comprises a received hole 41.

The ergonomic capacitance pen 10 is assembled as following steps in sequence: First, the electrical signal transmitting module 5 is put between the first shell 1 and the second shell 2, and the front end (or head) of the core 51 passes through the through hole 12 of the first shell 1. Next, the first tenon 13 of the first shell 1 is engaged into the notch 24 of the second shell 2 for fixing the first shell 1, the second shell 2, and the electrical signal transmitting module 5 together, and the battery 6 is put into the battery holder 54 through the space under the second shell 2. And then, the second shell 2 is integrated with the third shell 3. In this step, the third tenons 32 of the third shell 3 are inserted into the recessed holes 23 of the second shell 2 with a tilt, and then, the second tenons 22 of the second shell 2 are engaged into the notches 33 of the third shell 3 by moving the second shell 2 close to the third shell 3. Therefore, the second shell 2 and the third shell 3 are fixed together. After, the narrow end 21 of the second shell 2 and the narrow end 31 of the third shell 3 are inserted into the received hole 41 of the fourth shell 4. After these steps, assembling of the ergonomic capacitance pen 10 is finished and the ergonomic capacitance pen 10 after assembling is illustrated in FIG. 3.

According to foregoing embodiments illustrated in FIG. 2 and FIG. 3, it is understood that in this invention, the ergonomic capacitance pen can have a structure having best proportion of allocation for easily holding the ergonomic capacitance pen by changing the position of the battery in the ergonomic capacitance pen and putting the battery on one surface of the circuit board. When the battery put into the ergonomic capacitance pen, the body of the battery and the circuit board are parallel with each other. Although it makes the portion of the ergonomic capacitance pen, which the user holds to write, slightly bigger, but it decreases the burden of hand when the user uses of holds the ergonomic capacitance pen. Therefore, the user can use the ergonomic capacitance pen for a long time without the pain of the hand.

According to foregoing embodiments, the present invention provides an ergonomic capacitance pen. By changing where the battery is put in the ergonomic capacitance pen, the gravity center of the ergonomic capacitance pen is moved to the head portion (or the front portion or the lower portion) of the ergonomic capacitance pen. Therefore, the ergonomic capacitance pen can have a structure having best proportion of allocation for easily holding the ergonomic capacitance pen, and it is comfortable and suitable for long-time using without the pain of the hand.

What is claimed is:

1. An ergonomic capacitance pen, comprising:
an electrical signal transmitting module for emitting an electrical signal to a touch panel device wherein the electrical signal transmitting module comprises:
a core;
a core holder for holding the core;
a spring looped around the core holder;
a sensor holder for holding a sensor wherein the sensor is used to detect the pressure variation caused by movement of the core or the core holder;
a circuit board electrically connected with the spring; and
a battery holder deposited on one surface of the circuit board wherein the battery holder and the circuit board parallel with each other;
a housing for holding the electrical signal transmitting module wherein a head of the core is exposed outside the housing, and when a battery is put into the battery holder as a power supply of the ergonomic capacitance pen, the battery and the circuit board parallel with each other thereby the gravity center of the ergonomic capacitance pen moves to the position near the head of the ergonomic capacitance pen and the ergonomic capacitance pen can has a structure having best proportion of allocation for easily holding the ergonomic capacitance pen.

2. The ergonomic capacitance pen of claim 1, wherein the core, the core holder, and the spring are made of conductive materials.

3. The ergonomic capacitance pen of claim 1, wherein the battery holder is deposited on an upper surface of the circuit board.

4. The ergonomic capacitance pen of claim 1, wherein the battery holder is deposited on a lower surface of the circuit board.

5. The ergonomic capacitance pen of claim 1, wherein the housing comprises a button deposited thereon for switching on and switching off the ergonomic capacitance pen.

6. The ergonomic capacitance pen of claim 1, wherein the battery is a dry cell.

7. The ergonomic capacitance pen of claim 1, wherein the battery is a rechargeable Nickel-Metal Hydride battery.

8. The ergonomic capacitance pen of claim 1, wherein the housing comprises a first shell, a second shell, a third shell, and a fourth shell.

9. The ergonomic capacitance pen of claim 8, wherein the first shell comprises a button, a through hole, and a first tenon, the button is deposited on the upper surface of the first shell and the through hole and the first tenon are respectively deposited on two ends of the first shell.

10. The ergonomic capacitance pen of claim 8, wherein the second shell comprises a narrow end, a two second tenons, two recessed holes, and a notch.

11. The ergonomic capacitance pen of claim 8, wherein the third shell comprises a narrow end, two third tenons, and two notches.

12. The ergonomic capacitance pen of claim 8, wherein the fourth shell comprises a received hole.
